(19) United States
(12) Patent Application Publication
(10) Pub. No.: US 2014/0079066 A1
(43) Pub. Date: Mar. 20, 2014

(54) CUSTOMER PREMISE EQUIPMENT AND NETWORK ADDRESS TRANSLATION METHOD USING SAME

(71) Applicant: HON HAI PRECISION INDUSTRY CO., LTD., New Taipei (TW)

(72) Inventors: HONG-WEI TSENG, New Taipei (TW); BIN-RONG CHEN, New Taipei (TW)

(73) Assignee: HON HAI PRECISION INDUSTRY CO., LTD., New Taipei (TW)

(21) Appl. No.: 14/011,747

(22) Filed: Aug. 27, 2013

(30) Foreign Application Priority Data
Sep. 18, 2012 (TW) 101134099

(51) Int. Cl. H04L 45/749

(52) U.S. Cl. CPC H04L 45/741
USPC 370/392

(57) ABSTRACT

A customer premise equipment (CPE) capable of translating between different internet protocol (IP) address versions connects at least one local device to a network. A table is created for recording dual stack devices which support both IPv4 and IPv6 address versions. When a local device which is not recorded as a dual stack device in the table requests access to a remote device, an IP address of the remote device is analyzed. If the IP address of the remote device is determined to be not compatible with the IP address of the local device, a version of the IP address of the remote device is translated to be same as a version of the IP address of the local device, to enable communication between the local device and the remote device.

### BACKGROUND

1. Technical Field

Embodiments of the present disclosure relate to network address translation (NAT) technologies, and particularly to a network address translation method between IPv4 address device and an IPv6 address device in relation to customer premise equipment (CPE).

2. Description of Related Art Internet Protocol version 6 (IPv6) is a communications protocol that provides an identification and location system for computers on networks and routes traffic across the Internet. IPv6 is intended to replace IPv4. However, IPv4 still carries the largest part of Internet traffic. Since IPv6 is not compatible with IPv4, IPv6 devices/nodes may not directly communicate with IPv4 devices/nodes. Therefore, there is room for improvement in the art.

### BRIEF DESCRIPTION OF THE DRAWINGS

FIG. 1 is a schematic diagram illustrating one embodiment of a customer premise equipment (CPE) that is used to connect at least one local device to a network.

FIG. 2 is a schematic block diagram of one embodiment of the CPE of FIG. 1.

FIG. 3 is a flowchart of one embodiment of a network address translation method implemented by the CPE of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

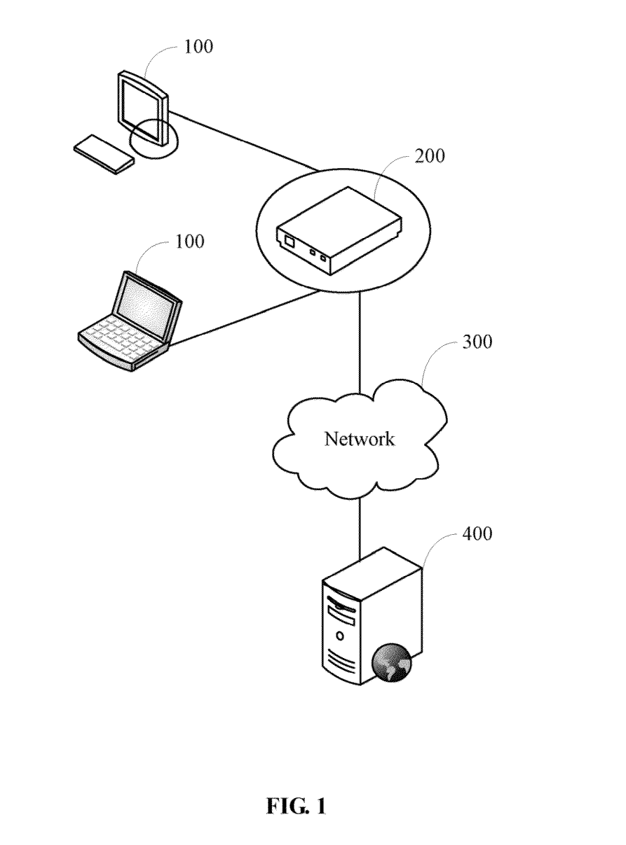

FIG. 1 is a schematic diagram illustrating one embodiment of a customer premise equipment (CPE) 200 that connects at least one local device 100 to a network 300. Thus, the at least one local device 100 can communicate with a remote device (e.g., a website server 400) via the network 300. In the embodiment, the at least one local device 100 and the remote devices may be, for example, single stack devices which only support Internet protocol version 4 (IPv4) or IPv6, or dual stack devices which support both IPv4 and IPv6.

In the embodiment, the communication network 300 may be a wireless network or a wired network. The CPE 200 may be a gateway or a router, which is connected to the at least one local device 100 via a wired connection (e.g., a data line) or a wireless connection (e.g., BLUETOOTH® OR WIFI®).

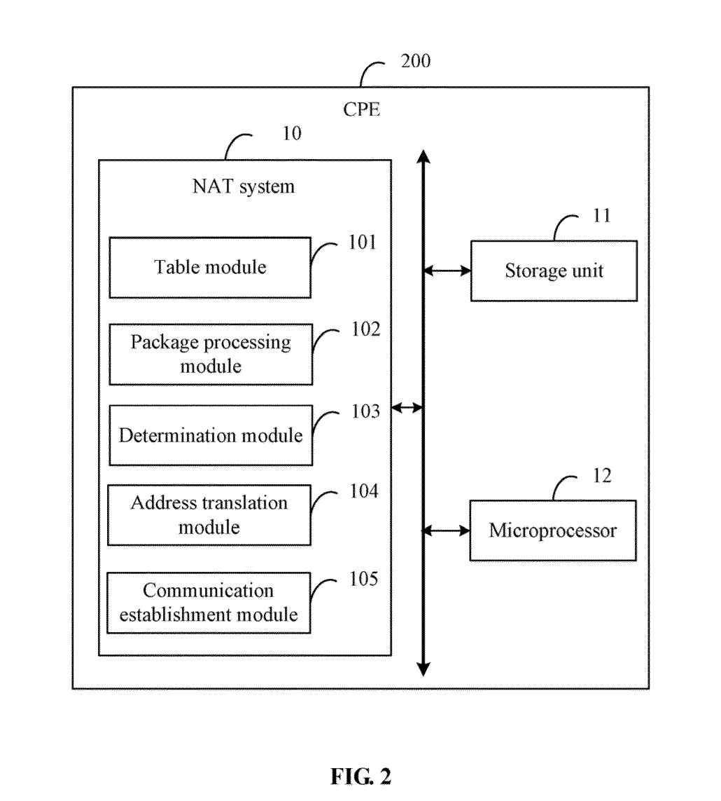

FIG. 2 is a schematic block diagram of the CPE 200 of FIG. 1. The CPE 200 includes a storage unit 11, a microprocessor 12, and a network address translation (NAT) system 10 including a plurality of functional modules. Each of the functional modules may include a plurality of programs in the form of one or more computerized instructions stored in the storage unit 11 or other storage medium and executed by the microprocessor 12 to perform operations of the CPE 200. In the embodiment, the NAT system 10 includes a table module 101, a package processing module 102, a determination module 103, an address translation module 104, and a communication establishment module 105.

In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

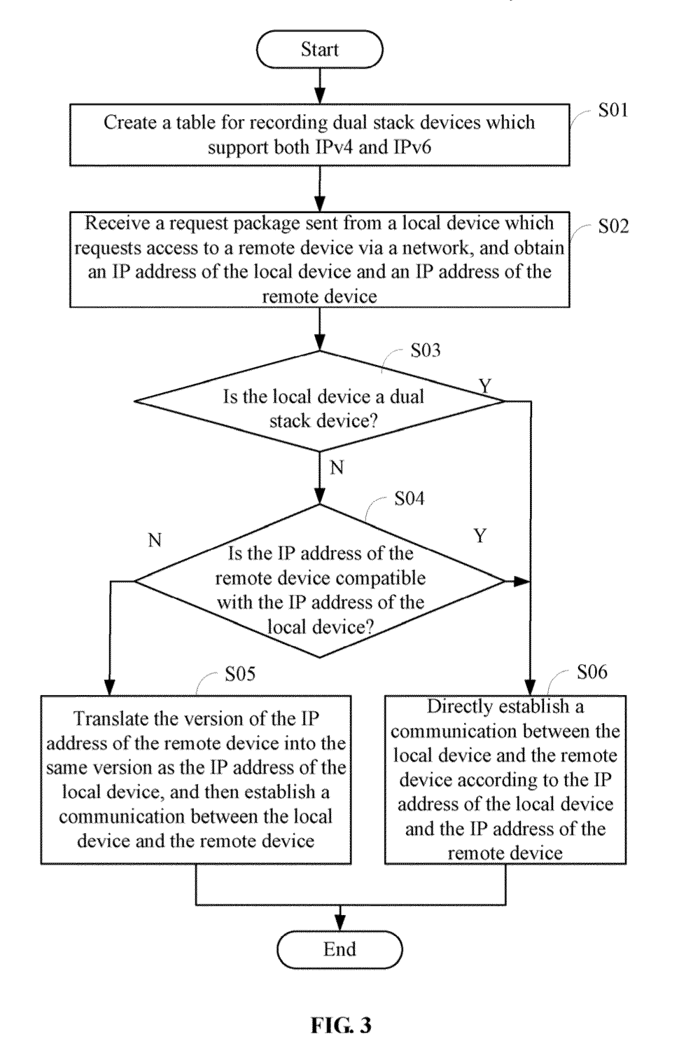

FIG. 3 is a flowchart of one embodiment of a network address translation method implemented by the functional modules 101-105 of the NAT system 10 of the CPE 200 of FIG. 1. Depending on the embodiment, additional steps may be added, others removed, and the ordering of the steps may be changed.

In step S01, the table module 101 creates a table for recording dual stack devices which support both IPv4 and IPv6, and records an IPv4 address and an IPv6 address of each dual stack device in the table. In the embodiment, when a local device 100 is connected to the CPE 200, a DNS (domain name server) query is sent to the CPE 200 by the local device 100. The table module 101 determines whether the local device 100 is a dual stack device according to a type of the DNS query. If the DNS query is an “A” type query, the local device 100 is a single stack device which only supports IPv4. If the DNS query is an “AAAA” type query, the local device 100 is a single stack device which only supports IPv6. If the DNS query includes both these types, the local device 100 is a dual stack device which supports both IPv4 and IPv6, and the IPv4 address and the IPv6 address of the local device are recorded in the table.

In step S02, the package processing module 102 receives a request package sent from a local device 100 which requests access to a remote device (e.g., the website server 400) via the network 300, and obtains an IP address of the local device 400 and an IP address of the remote device. The IP address of the local device 100 is obtained by analyzing the request package. The IP address of the remote device is obtained from a DNS server (not shown) of the network 300. For example, when the request package is received, the request package is sent to the DNS server of the network 300 by the package processing module 102, the DNS server parses a domain name of the remote device as it is included in the request package to obtain the IP address of the remote device, and then returns the IP address of the remote device to the CPE 200. In the embodiment, the IP address of the local device 100 and the IP address of the remote device may include an IPv4 address or an IPv6 address or both.

In step S03, the determination module 103 searches the table to determine whether or not the local device 100 is a dual stack device. If the local device 100 is not a dual stack device, step S04 is implemented. Otherwise, if the local device 100 is a dual stack device, step S06 is implemented.

In step S04, the determination module 103 further determines whether or not the IP address of the remote device is compatible with the IP address of the local device 100. In the embodiment, if the IP address of the remote device includes both an IPv4 address and an IPv6 address or if the IP address of the remote device is the same version as the IP address of the local device 100, the IP address of the remote device is thus compatible with the IP address of the local device 100, and step S06 is implemented. If the IP address of the remote device includes either an IPv4 address or an IPv6 address but not both, and the version of the IP address of the remote device is different from the version of the IP address of the local device 100, the IP address of the remote device is not compatible with the IP address of the local device 100, and step S05 is implemented.

In step S05, the address translation module 104 translates the version of the IP address of the remote device into the same version as the version of the IP address of the local device, and the communication establishment module 105 establishes a communication between the local device 100 and the remote device according to the translated IP address of the remote device, and the procedure ends.

In one embodiment, the address translation module 104 may use a compatible address method to translate between IP address versions. Based on the compatible address method, one of the local device and the remote device has an IPv6 address which includes a 96 bits of particular prefix (e.g. 64:ff9b::) and an embedded IPv4 address (e.g., 192.168.1.1). First, if the remote device has an IPv6 address (e.g., 64:ff9b::192.168.1.1) and the local device 100 has an IPv4 address (e.g., 10.153.28.45), the address translation module 104 translates the IPv6 version of the IP address of the remote device by extracting the embedded IPv4 address (e.g., 192.168.1.1) within the IPv6 address, and thus the extracted IPv4 address is the translated IP address of the remote device. Second, if the remote device has an IPv4 address and the local device 100 has an IPv6 address, the address translation module 104 translates the version of the IPv4 address of the remote device by adding the 96 bits of particular prefix to the IPv4 address of the remote device to form an IPv6 address, where the formed IPv6 address is thus the translated IP address of the remote device.

In another embodiment, the address translation module 104 may use a mapping address method in relation the remote device to translate between versions of the IP address. Based on the mapping address method, a dynamic address mapping table for recording a mapping relationship between an IPv4 address and an IPv6 address corresponding to a plurality of node devices presented on the network 300 is pre-created by the table module 101. In the embodiment, any communication device presented on the network 300 is regarded as a node of the network 300. In this regard, any communication device presented on the network 300 is defined as a node device. For example, both the local device and the remote device are defined as node devices. The address translation module 104 searches the dynamic address mapping table to determine whether or not the IP address of the remote device has been recorded in the dynamic address mapping table. If the IP address of the remote device has been recorded in the dynamic address mapping table, the address translation module 104 obtains an IPv4 address or an IPv6 address which has a mapping relationship with the IP address of the remote device from the dynamic mapping address table, where the obtained IPv4 address or IPv6 address is the translated IP address of the remote device. If the IP address of the remote device has not been recorded in the dynamic address mapping table, the address translation module 104 requests an IP address of the same version as the IP address of the local device 100 from an IP address pool of the network 300, where the requested IP address is thus the translated IP address of the remote device. Then, the table module 101 correlates the requested IP address and the IP address of the remote device and records the requested IP address and the IP address of the remote device into the dynamic address mapping table, to establish a mapping relationship between the requested IP address and the IP address of the remote device. In the embodiment, the IP address pool is defined to be a set of IP addresses available at any level in the IP address allocation hierarchy.

In step S06, the communication establishment module 105 directly establishes a communication between the local device 100 and the remote device via the network 300 according to the IP address of the local device 100 and the IP address of the remote device.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computerized network address translation method using a customer premise equipment (CPE) which connects at least one local device to a network, the CPE comprises a microprocessor to execute the method, the method comprising:
creating a table for recording dual stack devices which support both Internet protocol version 4 (IPv4) and Internet protocol version 6 (IPv6);
receiving a request package sent from a local device which requests access to a remote device via the network;
obtaining an IP address of the local device and an IP address of the remote device;
searching the table to determine whether or not the local device is a dual stack device;
determining whether or not the IP address of the remote device is compatible with the IP address of the local device when the local device is not a dual stack device;
translating the version of the IP address of the remote device into a same version as a version of the IP address of the local device; and
establishing communication between the local device and the remote device according to the IP address of the local device and the translated IP address of the remote device.

2. The method according to claim 1, further comprising:
establishing the communication between the local device and the remote device via the network according to the IP address of the local device and the IP address of the remote device, when the local device is the dual stack device.

3. The method according to claim 1, further comprising:
establishing the communication between the local device 1 and the remote device via the network according to the IP address of the local device and the IP address of the remote device, when the IP address of the remote device is compatible with the IP address of the local device.

4. The method according to claim 1, wherein the creating step comprises:
in response to a local device connected to the CPE sending a DNS query to the CPE, determining whether or not the local device is a dual stack device according to a type of the DNS query; and
recording the local device in the table when the local device is determined to be a dual stack device.

5. The method according to claim 4, wherein when the DNS query is an “A” type query, the local device is determined to be a single stack device which only supports IPv4; when the DNS query is an “AAAA” type query, the local device is determined to be a single stack device which only supports IPv6; when the DNS query includes both the “A” and “AAAA” types query, the local device is determined to be a dual stack device which supports both IPv4 and IPv6.

6. The method according to claim 1, wherein when the IP address of the remote device includes both an IPv4 address and an IPv6 address or if IP address of the remote device is the same version as the IP address of the local device, the IP address of the remote device is determined to be compatible with the IP address of the local device; when the IP address of the remote device includes either an IPv4 address or an IPv6 address but not both and the version of the IP address of the remote device is different from the version of the IP address of the local device, the IP address of the remote device is determined to be not compatible with the IP address of the local device.

7. The method according to claim 1, wherein the version of the IP address of the remote device is translated using a compatible address method when one of the local device and the remote device has an IPv6 address which includes a 96 bits of particular prefix and an embedded IPv4 address and another of the local device and the remote device has an IPv4 address, the compatible address method comprises:
in response to the remote device having the IPv6 address and the local device having the IPv4 address, extracting the embedded IPv4 address within the IPv6 address, and thus the extracted IPv4 address is the translated IP address of the remote device; and
in response to the remote device having the IPv4 address and the local device having the IPv6 address, adding the 96 bits of particular prefix to the IPv4 address of the remote device to form an IPv6 address, where the formed IPv6 address is thus the translated IP address of the remote device.

8. The method according to claim 1, further comprising:
creating a dynamic address mapping table for recording a mapping relationship between an IPv4 address and an IPv6 address corresponding a plurality of node devices presented on the network, where any communication device presented on the network is defined to be a node device.

9. The method according to claim 8, wherein the version of the IP address of the remote device is translated using a mapping address method, the mapping address method comprises:
searching the dynamic address mapping table to determine whether or not the IP address of the remote device has been recorded in the dynamic address mapping table; and
obtaining an IPv4 address or an IPv6 address which has a mapping relationship with the IP address of the remote device from the dynamic mapping address table when the IP address of the remote device has been recorded in the dynamic address mapping table, where the obtained IPv4 address or IPv6 address is the translated IP address of the remote device.

10. The method according to claim 9, wherein the mapping address method further comprises:
requesting an IP address of the same version as the IP address of the local device from an IP address pool of the network, where the requested IP address is thus the translated IP address of the remote device;
correlating the requested IP address with the IP address of the remote device; and
recording the requested IP address and the IP address of the remote device into the dynamic address mapping table, to establish a mapping relationship between the requested IP address and the IP address of the remote device.

11. A customer premise equipment (CPE) which connects at least one local device to a network, comprising:
a microprocessor;
one or more programs executed by the microprocessor to perform a method of:
creating a table for recording dual stack devices which support both Internet protocol version 4 (IPv4) and Internet protocol version 6 (IPv6);
receiving a request package sent from a local device which requests access to a remote device via the network;
obtaining an IP address of the local device and an IP address of the remote device;
searching the table to determine whether or not the local device is a dual stack device;
determining whether or not the IP address of the remote device is compatible with the IP address of the local device when the local device is not a dual stack device;
translating a version of the IP address of the remote device into a same version as a version of the IP address of the local device; and
establishing a communication between the local device and the remote device according to the IP address of the local device and the translated IP address of the remote device.

12. The CPE according to claim 11, wherein the method further comprises:
establishing the communication between the local device and the remote device via the network according to the IP address of the local device and the IP address of the remote device, when the local device is the dual stack device.

13. The CPE according to claim 11, wherein the method further comprises:
establishing the communication between the local device 1 and the remote device via the network according to the IP address of the local device and the IP address of the remote device, when the IP address of the remote device is compatible with the IP address of the local device.

14. The CPE according to claim 11, wherein the creating step comprises:
in response to a local device connected to the CPE sending a DNS query to the CPE, determining whether or not the local device is a dual stack device according to a type of the DNS query; and
recording the local device in the table when the local device is determined to be a dual stack device.

15. The CPE according to claim 14, wherein when the DNS query is an “A” type query, the local device is determined to be a single stack device which only supports IPv4; when the DNS query is an “AAAA” type query, the local device is determined to be a single stack device which only supports IPv6; when the DNS query includes both the “A” and “AAAA” types query, the local device is determined to be a dual stack device which supports both IPv4 and IPv6.

16. The CPE according to claim 11, wherein when the IP address of the remote device includes both an IPv4 address and an IPv6 address or if IP address of the remote device is the same version as the IP address of the local device, the IP address of the remote device is determined to be compatible with the IP address of the local device; when the IP address of the remote device includes either an IPv4 address or an IPv6 address but not both and the version of the IP address of the remote device is different from the version of the IP address of the local device, the IP address of the remote device is determined to be not compatible with the IP address of the local device.

17. The CPE according to claim 11, wherein the version of the IP address of the remote device is translated using a compatible address method when one of the local device and the remote device has an IPv6 address which includes a 96 bits of particular prefix and an embedded IPv4 address and another of the local device and the remote device has an IPv4 address, the compatible address method comprises:
in response to the remote device having the IPv6 address and the local device having the IPv4 address, extracting the embedded IPv4 address within the IPv6 address, and thus the extracted IPv4 address is the translated IP address of the remote device; and
in response to the remote device having the IPv4 address and the local device having the IPv6 address, adding the 96 bits of particular prefix to the IPv4 address of the remote device to form an IPv6 address, where the formed IPv6 address is thus the translated IP address of the remote device.

18. The CPE according to claim 11, wherein the method further comprises:
creating a dynamic address mapping table for recording a mapping relationship between an IPv4 address and an IPv6 address corresponding to a plurality of node devices presented on the network, where any communication device presented on the network is defined to be a node device.

19. The CPE according to claim 18, wherein the version of the IP address of the remote device is translated using a mapping address method, the mapping address method comprises:
searching the dynamic address mapping table to determine whether or not the IP address of the remote device has been recorded in the dynamic address mapping table; and
obtaining an IPv4 address or an IPv6 address which has a mapping relationship with the IP address of the remote device from the dynamic mapping address table when the IP address of the remote device has been recorded in the dynamic address mapping table, where the obtained IPv4 address or IPv6 address is the translated IP address of the remote device.

20. The CPE according to claim 19, wherein the mapping address method further comprises:
requesting an IP address of the same version as the IP address of the local device from an IP address pool of the network, where the requested IP address is thus the translated IP address of the remote device;
correlating the requested IP address with the IP address of the remote device; and
recording the requested IP address and the IP address of the remote device into the dynamic address mapping table, to establish a mapping relationship between the requested IP address and the IP address of the remote device.
